(19) United States
(12) Patent Application Publication
(10) Pub. No.: US 2019/0303867 A1
(43) Pub. Date: Oct. 3, 2019

(54) BLOCKCHAIN BASED CROWDSOURCING MEDICAL BILLING FOR MEDICAL INSURANCE CLAIMS PROCESSING

(71) Applicant: VINOD NAIR, Fremont, CA (US)

(72) Inventor: VINOD NAIR, Fremont, CA (US)

(21) Appl. No.: 16/367,294

(22) Filed: Mar. 28, 2019

Related U.S. Application Data
(60) Provisional application No. 62/648,962, filed on Mar. 28, 2018.

(51) Int. Cl. G06Q 10/10; G06Q 40/08; H04L 9/06

(52) U.S. Cl. CPC G06Q 10/10; H04L 2209/38; H04L 9/0637; G06Q 40/08

(57) ABSTRACT

A computer implemented method for detecting, validating and auto-adjudicate health insurance claims billing errors, rejections and potential claim denial in real-time using blockchain based platform, wherein, information or responses is provided by the live forum, plurality of medical biller community and healthcare service provider (HSP). The validation of the claim errors, rejections and potential claim denial for early detection, validation and correction of medical billing errors in real-time, further comprises steps of: initial feedback from the live forum comprising groups of unified biller community intelligence (UBCI), medical billers providing online response to medical related queries and questionnaires; and final validation of the claim errors, rejections and potential claim denial by matching value of the blockchain transaction to plurality of medical biller community server and healthcare service provider (HSP) server comprises verified stored records, as the blockchain based platform.

### CROSS REFERENCE TO RELATED APPLICATIONS

This application claims priority on U.S. Provisional Patent Application No. 62/648,962, entitled“BLOCKCHAIN BASED CROWDSOURCING MEDICAL BILLING FOR MEDICAL INSURANCE CLAIMS PROCESSING”, filed on Mar. 28, 2018, which is incorporated by reference herein in its entirety and for all purposes.

### FIELD OF THE INVENTION

The present invention provides a system and method for auto-adjudicate health insurance claims billing errors in real-time by using blockchain based system. More specifically, the present invention relates to a blockchain based system and method for claims adjudication and health insurance claims billing management, by referencing set of known and identified medical billing information and/or responses data provided by medical biller communities.

### BACKGROUND OF THE INVENTION

Today, main problems for health care systems is how to share error-free medical billing data; and reimbursement process with healthcare industries, insurance payers and other stakeholders, while ensuring speed and accuracy of medical claims, data integrity and protecting individual privacy.

Currently, the healthcare industry has used an electronic-based technology for recording, maintaining and tracking medical information such as a physician's medical summary, the physician's billing, the insurance company's payment, payment reimbursement record, medical billing code etc. These health-related data are not always stored by a single healthcare provider. Every insurer medical bill final reimbursement by payers are fragmented and spread across multiple healthcare providers' systems. Therefore, not only does this make it difficult for health data to be joined, it also leaves data vulnerable to theft. When data is split between multiple providers and their stakeholders, there is considerable potential for a breach and data theft.

The growing focus on electronic health record (EHR) access has raised questions about how to ensure that multiple providers can view, edit, and share medical data while still maintaining an authoritative and up-to-date record of diagnoses, medications, medical billing record, payment reimbursement, and services rendered. Moreover, the healthcare industry is inundated with excessive paperwork, and is complex and burdened with outdated billing and collection systems. Thereby, insurance companies incur significant expenses overseeing and ensuring that reasonable protocols are followed. Even then, insurance companies are susceptible to fraudulent medical claims by insurer. This increases medical claims denials and insurance costs which in turn generally increases healthcare costs, which adversely affects employers, insurance companies, and healthcare service providers. The more the entities have access to health data, the greater the potential for errors to be made that result in the data being exposed. The Health Insurance Portability and Accountability Act (HIPAA) require all HIPAA covered entities and their stakeholders to implement technical safeguards to ensure the confidentiality, integrity, and availability of protected health information. However, each entity implements their own security controls.

The state-of-the-art systems provide methods of validating healthcare transactions:

US20150332283A1 provides healthcare transaction validation systems and methods are presented. Healthcare transactions associated with a stakeholder are compiled into a chain of healthcare transaction blocks. The chain can be considered a chronicle of person's healthcare path through life. When a transaction is conducted, the corresponding healthcare parameters (e.g., inputs, outputs, clinical evidence, outcomes, etc.) are sent to one or more validation devices. The devices establish a validity of the transaction and generate a new block via a proof-of-work principle. Once the new block has been calculated it can be appended to the stakeholder's health care blockchain;

US20180060496A1 provides technologies to secure flexible access to the healthcare information resources (HIR) contained within electronic health records (EHR) systems. By managing access permissions with certified self-sovereign identities and distributed ledger techniques, HIR may be secured. Patients and other users may be registered to access a distributed ledger, such as a healthcare blockchain, employed to set, host and adjudicate permissions to access HIR. Authorized owners and/or patients with rights to their own HIR may be able to grant fine-grained and conditional access permissions to third-parties. Information transfers and transactions occurring according to these permissions may be logged within smart contracts incorporated in the healthcare blockchain; and

CN107247773A provides a method for implementing transaction query in a distributed database on the basis of a block chain. The method comprises the following steps: designing a Bloom filter, and finding out a candidate block which comprises an assigned transaction ID according to the designed Bloom filter; traversing and screening the candidate block, finding out a specific block, which comprises a transaction ID, of target transaction, and then constructing a Verify Message; verifying the completeness of a transaction path of the block by analysis of the Verify Message; and returning corresponding information according to a verify result, and implementing query of optional transaction in the distributed database on the basis of the block chain. By the method, query of the optional transaction in the distributed database on the basis of the block chain is realized, and the utilization rate of data of the block chain is increased.

The cited prior art herein provides a blockchain system and method, that analyses particularly a method of block-based chain of transactions in a distributed database query or provide functionality for enabling electronic access to protected health information (PHI) according to the wishes of a patient and/or other authorized parties or a method of validating healthcare transactions. None of the disclosed methods can include about medical claims error receiving, validating by one or more validation devices.

To remedy these limitations, it is advantageous to have a system and method that provides error-free medical billing related information in real time to physicians, patients, employers, insurance companies and other individuals, and/or entities involved in the field with the assured integrity from the point of data generation to the point of use, without manual or human intervention. Also, to provide a computer implemented system and method solutions for healthcare industry which has the potential to enable secure lifetime medical billing record sharing across health care service providers.

### SUMMARY OF THE INVENTION

The present invention relates to blockchain based system, method for detecting, validating and auto-adjudicating the medical claim errors, rejections and potential denial issues in real-time by comparing set of known references and identified medical billing information and/or responses data of similar hash value produced by the group of medical billers that is stored and verified in the blockchain based platform, after an initial scrutiny by a live crowdsourcing data or live forum. Accordingly, the main embodiment of the invention is to provide a blockchain based system and method to detect, validate and adjudicate error-free medical billing, by initial scrutiny of the medical claims before submission or before re-submission in real time via alive forum comprising groups of unified biller community intelligence (UBCI), medical billers providing online response to medical related queries and questionnaires physicians, patients, employers, insurance companies and other individuals, and/or entities involved in the field.

Another embodiment of the present invention is to provide a blockchain based system and a method to detect, validate and provide error-free medical billing, by final scrutiny of the medical bill before submission or before re-submission in real time via by comparing, validating and compiling a comprehensive blockchain based platform with plurality of medical biller community server and healthcare service provider (HSP) server.

Yet another embodiment of the present invention is to provide a decentralized blockchain system and method that allows any approved medical biller or group of medical billers to join an exchange community, live and provide solution without the need to build data exchange pipes/servers between certain entities.

In another embodiment of the present invention, the blockchain system enabled device executes a web browser for interpreting HTML or other display instructions in a web page. The system for detecting, validating and adjudicating the claim errors, rejections and potential claim denial in real-time using blockchain based platform database, the method comprising the steps of: (a) a hash value blockchain generator for regenerating a hash value for a first medical biller with identifier hash for distinguishing among entries, a record hash for respective recording, and the data hash; (b) a plurality of health blockchain for communicating the hash value to a second medical biller through a blockchain network in which the blockchain network adds information or responses in the data hash to one or more blocks in an existing blockchain; and (c) a blockchain based platform for verifying the medical bills by matching value of the blockchain transaction with the blockchain based platform, wherein, information or responses is provided by the live forum, plurality of medical biller community and healthcare service provider (HSP); validation of the claim errors, rejections and potential claim denial for early detection, validation and correction of medical billing errors in real-time, further comprises steps of:

initial feedback from the live forum comprising groups of unified biller community intelligence (UBCI), medical billers providing online response to medical related queries and questionnaires; and
final validation of the claim errors, rejections and potential claim denial by matching value of the blockchain transaction to plurality of medical biller community server and healthcare service provider (HSP) server comprises verified stored records, as the blockchain based platform.

In yet another embodiment of the present invention, the blockchain based platform is a commercial digital distributed ledger that stores live crowdsourcing data or live forum data from large-scale medical billing user communities and other users, exchanging live discrete information into commercial digital distributed ledger and verified by validators.

In yet another embodiment of the present invention, the blockchain based platform is used for storing live medical related queries and questionnaire by groups of medical biller users i.e. Unified Billing Community Intelligence and verified by authority/validators that not only for keeping medical records secure but pulling together fragmented medical records stored by multiple Unified Billing Community Intelligence providers.

In yet another embodiment of the present invention, a blockchain based platform is used to verify and track in a distributed ledger the availability of one or more portions of a divisible resource that can be distributed amongst a plurality of users. When a user requests a portion of a resource and is assigned the requested portion, the user incurs the obligation to return the resource in accordance with the rules governing the resource, such as, for example, the passage of a predetermined period of time. In contexts where the resource is highly divisible, the block chain database can be used to track the return of portions of the requested resource and document the partial satisfaction of the user's obligation to return the resource.

In carrying out the above embodiments of the present invention, a computer implemented method for detecting, validating and adjudicating the claim errors, rejections and potential claim denial in real-time using blockchain based platform database, the method comprising the steps of: a) generating a hash value of a first medical biller with identifier hash for distinguishing among entries, a record hash for respective recording, and the data hash; b) sending the hash value to a second medical biller through a blockchain network in which the blockchain network adds information and/or responses in the data hash to one or more blocks in an existing blockchain; and c) validating the claim errors, rejections and potential claim denial by matching the hash value the first medical biller to a similar or same hash value of the blockchain transaction with a blockchain based platform, wherein, information or responses is provided by the live forum, plurality of medical biller community and healthcare service provider (HSP); validation of the claim errors, rejections and potential claim denial for early detection, validation and correction of medical billing errors in real-time, further comprises steps of: initial feedback from the live forum comprising groups of unified biller community intelligence (UBCI), medical billers providing online response to medical related queries and questionnaires; and final validation of the claim errors, rejections and potential claim denial by matching value of the blockchain transaction to plurality of medical biller community server and healthcare service provider (HSP) server comprises verified stored records, as the blockchain based platform.

In accordance with an aspect of the present invention broadly described herein, a method for processing medical billing claim by initiating and submitting medical claim by healthcare service providers (HSP) or other users is provided. Then, the commercial blockchain based platform provides input information from verified data by groups of medical biller users i.e. Unified Billing Community Intelligence; and detects, validates and corrects claim errors, rejections, and potential denial issues in real-time.

In yet another embodiment of the present invention, the invention provides a method for facilitating detection and correction of medical billing errors in real-time before medical claim submission by secure medical billing database management generated by live forum of unified biller community intelligence (UBCI), wherein the secure medical billing database management is being maintained in a blockchain based platform comprised of plurality of medical biller community server and healthcare service provider (hsp) server.

### BRIEF DESCRIPTION OF THE DRAWING

The present invention may be understood in more details and more particularly description of the invention briefly summarized above by reference to certain embodiments thereof which are illustrated in the appended drawings, which drawings form a part of this specification. It is to be noted, however, that the appended drawings illustrate preferred embodiments of the invention and are therefore not to be considered limiting of its scope, for the invention may admit to other equally effective equivalent embodiments.

FIG. 1 is a schematic of blockchain based system and method for detecting, validating and adjudicating the claim errors in accordance with an embodiment of the invention;

FIG. 2 provides blockchain system environment architecture, in accordance with one embodiment of the present invention;

FIG. 3 illustrates blocks in a blockchain based platform in accordance with an embodiment of the invention; and

FIG. 4 provides a process flow illustrating a block chain provided for facilitating, detecting and adjudicating medical billing errors in real-time, in accordance with an embodiment of the present invention.

### DETAILED DESCRIPTION OF THE INVENTION

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this invention will be thorough, and will fully convey the scope of the invention to those skilled in the art.

In an embodiment of the present invention, the method and system provide a decentralized blockchain based platform that documents the data transfer from one creator to other or various end-users, and/or between end users. The system and method enable use of commercial blockchain otherwise known as a distributed ledger to create live medical related data groups of medical billers such as Unified Billing Community Intelligence and provide as live crowdsourcing data and store this publicly verifiable record of digital transactions in a blockchain based platform. The Blockchain system provides decentralized distributed ledger or a public ledger, and a transaction database. The commercial blockchain system analyses the given medical billing identified query against one or more set of known and identified medical billing elements stored in the blockchain based platform by the medical biller's community. The system allows the data to be stored, modified, maintained, and verified on several independent nodes and establishes security by keys on the database rather than the source and origin of the information. In an event of a member making a transaction, date and time is stamped along with a key using the member's private key such as biometrics, or any form of unique identification.

In yet another embodiment, the system records every subsequent medical transaction related data and/or query, and a new key is generated into blockchain system which includes the earlier key. The present blockchain system provides each data block in the chain in an encrypted form using public key cryptography which can be unlocked while processing medical claim errors with the use of a private key or password, which could be held by healthcare service providers, UBCI users, and/or seekers. Hence, without access to the key, the data stored in blockchain is inaccessible and it is impossible to hack in a single block of data or changes to the data blocks to be made.

In an embodiment of the present invention a computer implemented method for detecting, validating and adjudicating the claim errors, rejections and potential claim denial in real-time using blockchain based platform database before re-submission, the method comprising the steps of: a) re-generating a hash value of a first medical biller with identifier hash for distinguishing among entries, a record hash for respective recording, and the data hash; b) sending the hash value to a second medical biller through a blockchain network in which the blockchain network adds information and/or responses in the data hash to one or more blocks in an existing blockchain; and c) validating the claim errors, rejections and potential claim denial by matching the hash value the first medical biller to a similar or same hash value of the blockchain transaction with a blockchain based platform, wherein, information or responses is provided by the live forum, plurality of medical biller community and healthcare service provider (HSP); validation of the claim errors, rejections and potential claim denial for early detection, validation and correction of medical billing errors in real-time, further comprises steps of: initial feedback from the live forum comprising groups of unified biller community intelligence (UBCI), medical billers providing online response to medical related queries and questionnaires; and final validation of the claim errors, rejections and potential claim denial by matching value of the blockchain transaction to plurality of medical biller community server and healthcare service provider (HSP) server comprises verified stored records, as the blockchain based platform.

In yet another embodiment the system for detecting, validating and adjudicating the claim errors, rejections and potential claim denial in real-time using blockchain based platform database, the method comprising the steps of: a) a hash value blockchain generator for regenerating a hash value for a first medical biller with identifier hash for distinguishing among entries, a record hash for respective recording, and the data hash; b) a plurality of health blockchain for communicating the hash value to a second medical biller through a blockchain network in which the blockchain network adds information or responses in the data hash to one or more blocks in an existing blockchain; and c) a blockchain based platform for verifying the medical bills by matching value of the blockchain transaction with the blockchain based platform, wherein, information or responses is provided by the live forum, plurality of medical biller community and healthcare service provider (HSP); validation of the claim errors, rejections and potential claim denial for early detection, validation and correction of medical billing errors in real-time, further comprises steps of: initial feedback from the live forum comprising groups of unified biller community intelligence (UBCI), medical billers providing online response to medical related queries and questionnaires; and final validation of the claim errors, rejections and potential claim denial by matching value of the blockchain transaction to plurality of medical biller community server and healthcare service provider (HSP) server comprises verified stored records, as the blockchain based platform.

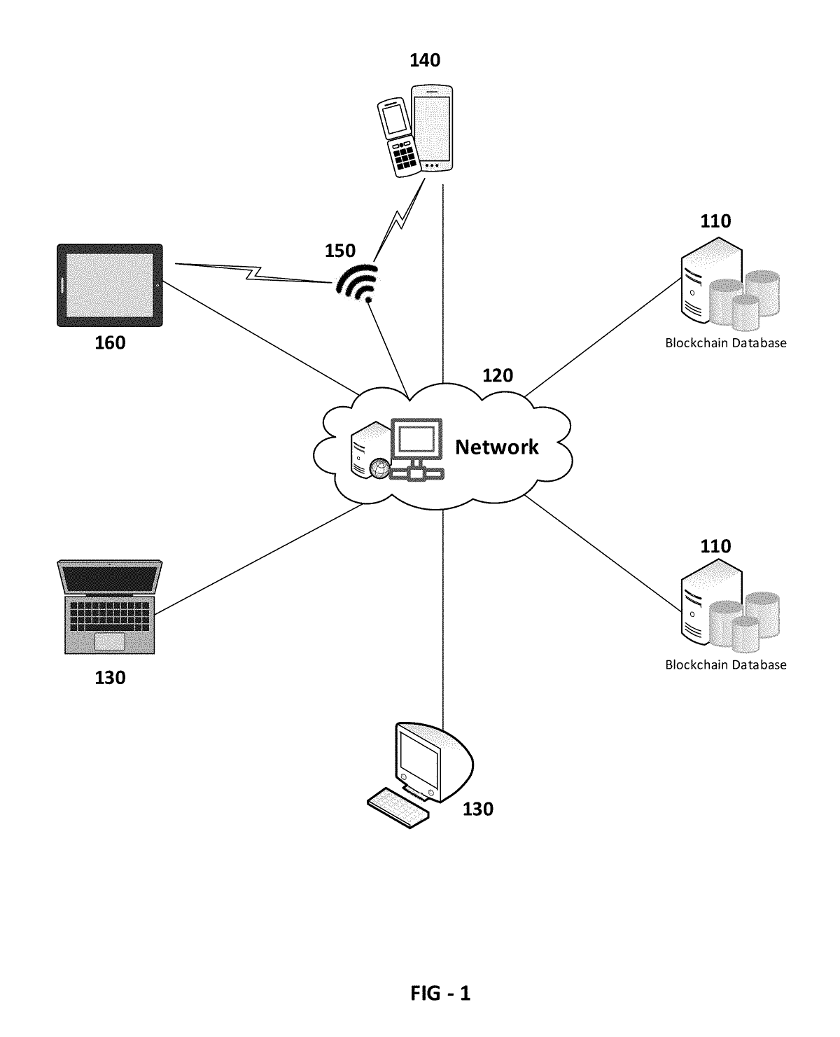

In FIG. 1 a blockchain based system in accordance with an embodiment of the invention is illustrated. The system (100) includes a blockchain based platform (110) that communicates with one or more nodes via a network (120). Additionally, the system (100) includes a variety of digital devices that may run on hardware such as personal computers (130), mobile phones (140), personal computing devices (160), some of which may communicate on the network 120 via a wireless access point (150). The blockchain based system (100) comprising a blockchain based platform (110) configured to create an initial genesis block in a ledger file. This new ledger file may be transmitted over the network (120) to other nodes including digital devices (130), (140), (160), and other blockchain management devices (110). In many embodiments, blockchain based system (100) is decentralized in which entire copies of a particular ledger file are stored on multiple nodes. In other embodiments, some copies may be a pruned copy of the ledger file. Participating nodes may utilize a copy of the ledger and make the transaction history available for download to others per default via network (120) such as by utilizing peer-to-peer protocols.

In an embodiment of the present invention, the invention provides blockchain system environment architecture 200, in accordance with an embodiment of the present invention. The invention uses a decentralized blockchain based platform configuration or architecture that enables a reduction in overhead costs, particularly for development and maintenance of medical claim billing systems. The successful deployment of blockchain for error-free medical claim records allows data transition in real-time between related parties in an efficient, consensus-based, seamless manner to ensure every claim are paid upon the first claim submission to payers. The decentralized nature of the blockchain system allows approved medical biller or group of medical billers to join an exchange community live and provides solution without the need to build data exchange pipes/servers between certain entities. Furthermore, the present blockchain system provides medical billing management workflow to enable the medical claim to be complete, accurate, and timely to ensure every claim are paid upon the first claim submission to payers.

In another embodiment of the present invention, the blockchain system operates as a standalone system or in conjunction by connecting to other medical billing platforms at various stages, or as a separate framework. The blockchain system comprises live crowdsourcing data by medical billers is implemented and executed on a device. The device can be a handheld device and/or web-enabled device and/or desktop enabled personal computer that comprises a processor, an addressable memory, and other conventional features such as a display, local memory, input/output ports, and a network interface. The blockchain system enabled device executes a web browser for interpreting HTML or other display instructions in a web page.

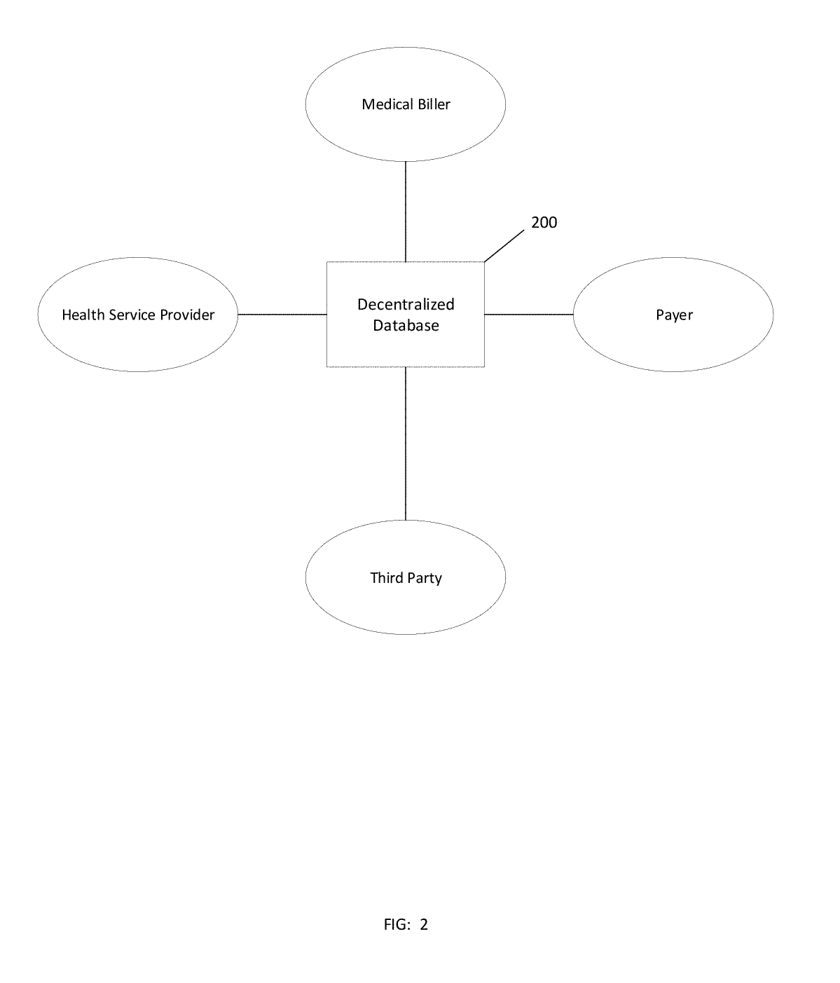

As shown in FIG. 2, the decentralized blockchain based platform stores live crowdsourcing data from large-scale medical billing users' communities and other users, exchanging live discrete information into commercial digital distributed ledger and facilitate validation and verification the given medical billing identified query against one or more set of known and identified medical billing elements store in the blockchain based platform by the medical biller's community. Such a decentralized block chain configuration ensures storing live medical related queries and questionnaire by groups of medical biller users i.e. Unified Billing Community Intelligence and verified by authority/validators that not only for keeping medical records secure but pulling together fragmented medical records stored by multiple Unified Billing Community Intelligence providers.

Accordingly, a block chain configuration may be used to maintain an accurate ledger of resources from the medical billers community (UBCI) comprises experts, skilled, novice and experienced medical billers, medical coders, claims auditors, practice consultants, denial management experts, account receivables and medical practitioners, billing managers, practice administrators and other related medical billing professionals together referred herein as “medical billers” or “medical billing users”, who are sharing expertise, complex billing know-how, payer nuances and other information to help each other in real-time using shared expertise of similar claims, payers, specialties of a billable codes (CPT/HCPCS) and other related combinations into different questionnaire and their answers on the live forum and storing into digital distributed ledger.

The fundamental structure of a decentralized blockchain ledger includes blocks which are linked together to form a blockchain. The present blockchain based platform system, for every medical claim submission, would not have to take much time to gather records from multiple providers and medical billing elements data from UBCI, and to send these medical billing data to their insurance payers in real-time. The blockchain system also allows simply to be added such as the new specialist, new insurance payers, or new rules and regulation to the database. From there, users can access the same information as everyone else already participating.

In additional embodiments, assets in a blockchain are represented by a hash (sometimes referred to as a cryptographic hash). The use of a database listing meta data of creations with their respective hashes can aide in the search for creations in the block chain. In certain embodiments, this database is stored within the blockchain itself. In certain other embodiments, the database is stored externally from the blockchain and referenced by methods including, but not limited to, links to other blocks in different block chains, hard drive sector locations, and/or URL addresses.

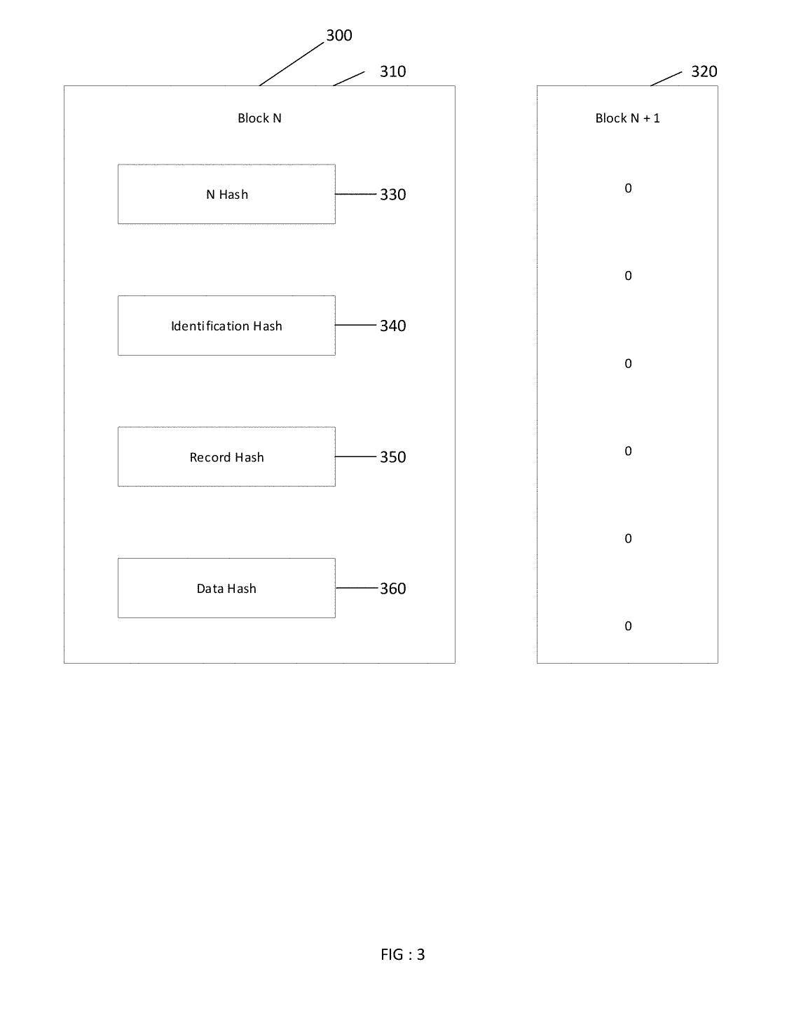

FIG. 3 illustrates blocks in a blockchain based platform in accordance with an embodiment of the invention. In an embodiment of the present invention, the ledger block chain segment (300) contains a first block N (310) for a first medical biller and a subsequent block N+1 320 for a second medical biller and so on. In a number of embodiments, each block contains a hash value in the chain. When a hash value is generated at a first medical biller at block N hash (330) its subsequent answer as identification hash (340), a record hash (350) and a data hash (360). The hash value generated from the first medical biller will be recorded and a portion of the hash value is sent for identification to a second medical biller. Then, the blockchain based platform provides input information from verified data by groups of medical biller users i.e. Unified Billing Community Intelligence and healthcare service provider (hsp) server, and detects, validates and corrects claim errors rejections and potential denial issues in real-time.

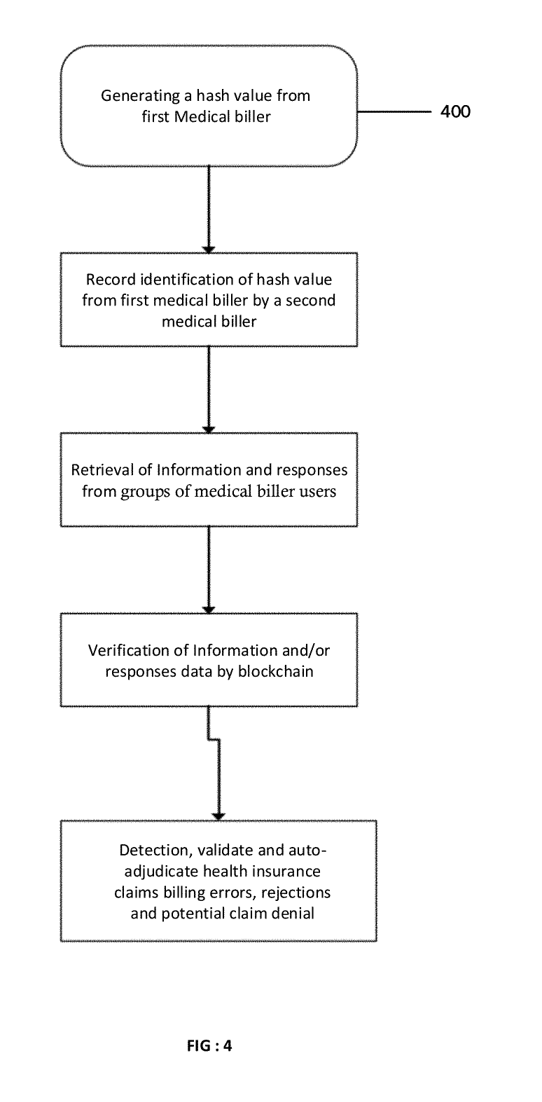

As shown in FIG. 4 a process (400) for facilitating, detecting, and detecting, validating and auto-adjudicate health insurance claims billing errors, rejections and potential claim denial in real-time, which comprises regenerating a hash value at a first medical biller based on medical query and their answer as identification hash, a record hash and a data hash. Then the hash value of first medical biller is sent for record identification to a second medical biller, from the first medical biller device. Then the record identification and the portion of the hash value generated form second medical biller device is be sent to the core server for retrieval of de-identified data. Then blockchain based platforms verify the hash value using the transaction identification, from the second client device. The blockchain based platform provides input information from verified data by groups of medical biller users i.e. Unified Billing Community Intelligence, medical biller community server, and healthcare service provider (hsp) server, and detects, validates and corrects claim errors, rejections, and potential denial issues in real-time.

Although the subject matter presented herein has been described in language specific to computer structural features, methodological acts, and computer readable media, it is to be understood that the present disclosure is not necessarily limited to the specific features, acts, or media described herein. Rather, the specific features, acts and mediums are disclosed as example forms.

Although the methods as described with reference to the flow diagram illustrated in FIGS. 1-4, many other operations for performing the acts associated with the methods may be used. For example, the order of the operations may be changed, some of the operations described may be optional, and additional operations may be included, in accordance with example embodiments of the disclosure. For example, information and/or responses from live forum of medical billers within the blockchain system could be configured to other blockchain-based systems thus endowed the network with limitless applications use case potential.

The subject matter described above is provided by way of illustration only and should not be construed as limiting. Various modifications and changes can be made to the subject matter described herein without following the example configurations and applications illustrated and described, and without departing from the true spirit and scope of the present invention.

The disclosure is described above with reference to block and flow diagrams of systems, methods, apparatuses, and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented or may not necessarily need to be performed at all, according to some embodiments of the disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, comprising a computer usable medium having a computer readable program code or program instructions embodied therein, said computer readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or

Accordingly, blocks of the block diagrams and flow diagrams support combinations of mechanisms for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

It will be appreciated that each of the memories and data storage devices described herein can store responses data and information for subsequent retrieval. The memories and databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the databases shown can be integrated or distributed into any number of databases or other data storage devices.

Many modifications and other embodiments of the present invention disclosure set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

I claim:

1. A computer implemented method for detecting, validating and auto-adjudicate health insurance claims billing errors, rejections and potential claim denial in real-time using blockchain based platform database, the method comprising the steps of:
a) generating a hash value of a first medical biller with identifier hash for distinguishing among entries, a record hash for respective recording, and the data hash;
b) sending the hash value to a second medical biller through a blockchain network in which the blockchain network adds information and/or responses in the data hash to one or more blocks in an existing blockchain; and
c) validating the claim errors, rejections and potential claim denial by matching the hash value the first medical biller to a similar or same hash value of the blockchain transaction with a blockchain based platform,
wherein,
information or responses is provided by the live forum, plurality of medical biller community and healthcare service provider (HSP);
validation of the claim errors, rejections and potential claim denial for early detection, validation and correction of medical billing errors in real-time, further comprises steps of:
initial feedback from the live forum comprising groups of unified biller community intelligence (UBCI), medical billers providing online response to medical related queries and questionnaires; and
final validation of the claim errors, rejections and potential claim denial by matching value of the blockchain transaction to plurality of medical biller community server and healthcare service provider (HSP) server comprises verified stored records, as the blockchain based platform.

2. The method for auto-adjudicate health insurance claims billing errors of claim 1, wherein a decentralized nature of the blockchain system allows any approved medical biller or group of medical billers to join a live exchange community

3. The method for auto-adjudicate health insurance claims billing errors of claim 1, wherein the blockchain based platform provides blockchain transaction details from verified data by groups of medical biller users

4. A computer implemented method for detecting, validating and auto-adjudicate health insurance claims billing errors, rejections and potential claim denial in real-time using blockchain based platform database before re-submission, the method comprising the steps of:
a) re-generating a hash value of a first medical biller with identifier hash for distinguishing among entries, a record hash for respective recording, and the data hash;
b) sending the hash value to a second medical biller through a blockchain network in which the blockchain network adds information and/or responses in the data hash to one or more blocks in an existing blockchain; and
c) validating the claim errors, rejections and potential claim denial by matching the hash value the first medical biller to a similar or same hash value of the blockchain transaction with a blockchain based platform,
wherein,
information or responses is provided by the live forum, plurality of medical biller community and healthcare service provider (HSP);
validation of the claim errors, rejections and potential claim denial for early detection, validation and correction of medical billing errors in real-time, further comprises steps of:
initial feedback from the live forum comprising groups of unified biller community intelligence (UBCI), medical billers providing online response to medical related queries and questionnaires; and
final validation of the claim errors, rejections and potential claim denial by matching value of the blockchain transaction to plurality of medical biller community server and healthcare service provider (HSP) server comprises verified stored records, as the blockchain based platform.

5. The method for auto-adjudicate health insurance claims billing errors of claim 4, wherein, the blockchain system allows any approved medical biller or group of medical billers to join an exchange community live and provides solution

6. The method for auto-adjudicate health insurance claims billing errors of claim 4, wherein, blockchain based platform provides blockchain transaction details from verified data by groups of medical biller users

7. A system for detecting, validating and auto-adjudicate health insurance claims billing errors, rejections and potential claim denial in real-time using blockchain based platform database, the method comprising the steps of:
a) hash value blockchain generator for regenerating a hash value for a first medical biller with identifier hash for distinguishing among entries, a record hash for respective recording, and the data hash;
b) plurality of health blockchain for communicating the hash value to a second medical biller through a blockchain network in which the blockchain network adds information or responses in the data hash to one or more blocks in an existing blockchain; and
c) a blockchain based platform for verifying the medical bills by matching value of the blockchain transaction with the blockchain based platform,
wherein,
information or responses is provided by the live forum, plurality of medical biller community and healthcare service provider (HSP);
validation of the claim errors, rejections and potential claim denial for early detection, validation and correction of medical billing errors in real-time, further comprises steps of:
initial feedback from the live forum comprising groups of unified biller community intelligence (UBCI), medical billers providing online response to medical related queries and questionnaires; and
final validation of the claim errors, rejections and potential claim denial by matching value of the blockchain transaction to plurality of medical biller community server and healthcare service provider (HSP) server comprises verified stored records, as the blockchain based platform.
